(19) United States
(12) Patent Application Publication
(10) Pub. No.: US 2016/0203245 A1
(43) Pub. Date: Jul. 14, 2016

(54) METHOD FOR SIMULATING WIND FIELD OF EXTREME ARID REGION BASED ON WRF

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); JIAN-MEI ZHANG, Beijing (CN); SHI-EN HE, Beijing (CN); YAN-HONG MA, Beijing (CN); LONG ZHAO, Beijing (CN); QIANG ZHOU, Beijing (CN); MING MA, Beijing (CN); GUANG-TU LIU, Beijing (CN); DING-MEI WANG, Beijing (CN); LIANG LU, Beijing (CN); QING-QUAN LV, Beijing (CN); XIAO-YONG WANG, Beijing (CN); RONG HUANG, Beijing (CN); KUN DING, Beijing (CN); JIN LI, Beijing (CN); SHI-YUAN ZHOU, Beijing (CN); JIN-PING ZHANG, Beijing (CN)

(21) Appl. No.: 14/597,177

(22) Filed: Jan. 14, 2015

(51) Int. Cl. G06F 17/50; G06F 17/10

(52) U.S. Cl. CPC G06F 17/5009; G06F 17/10

(57) ABSTRACT

A method of simulating wind field of extreme arid region based on WRF includes following steps. A mode parameter optimization scheme for wind energy simulation is selected, wherein the mode parameter optimization scheme is selected by selecting a group of mode parameter optimization schemes of different ground floors, land process, and planet boundary layers having great influence on simulation of the boundary layer of wind field, and comparing the mode parameter optimization schemes. A wind energy simulation of the extreme arid region is performed during a preset length of time using the selected mode parameter optimization scheme. Simulation configuration of the wind field for the extreme arid region is obtained through results of the wind energy simulation.

### BACKGROUND

1. Technical Field

The present disclosure relates to a method of simulating wind field of extreme arid region based on WRF (Weather Research and Forecasting Model).

2. Description of the Related Art

In recent years, the wind power industry in China has developed rapidly, a large number of large-scale wind turbine grid urgently requires our country to develop its own wind power technology. The wind energy forecasting system is an important technology for wind power at production scheduling, integration of wind turbines, and requires extra attention.

At present, wind forecasting methods comprises statistical type forecasting, and power forecasting. The statistical type forecasting is to establish time series model predict and seeking the correlation. They are forecasting method based on probability and statistics. Many parameterization schemes are derived from the present wind forecasting methods.

However, because the climatic characteristics and land surface properties at extreme arid region are quite different from other area, thus the parameters in the present model cannot be applied in the extreme arid region.

What is needed, therefore, is a method of simulating wind field of extreme arid region that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flow chart of one embodiment of a method of simulating wind field of extreme arid region.

### DETAILED DESCRIPTION

The disclosure is illustrated by way of example and not by way of limitation in the FIGURES of the accompanying drawings in which like references indicate similar elements. It should be noted that references to “an” or “one” embodiment in this disclosure are not necessarily to the same embodiment, and such references mean at least one.

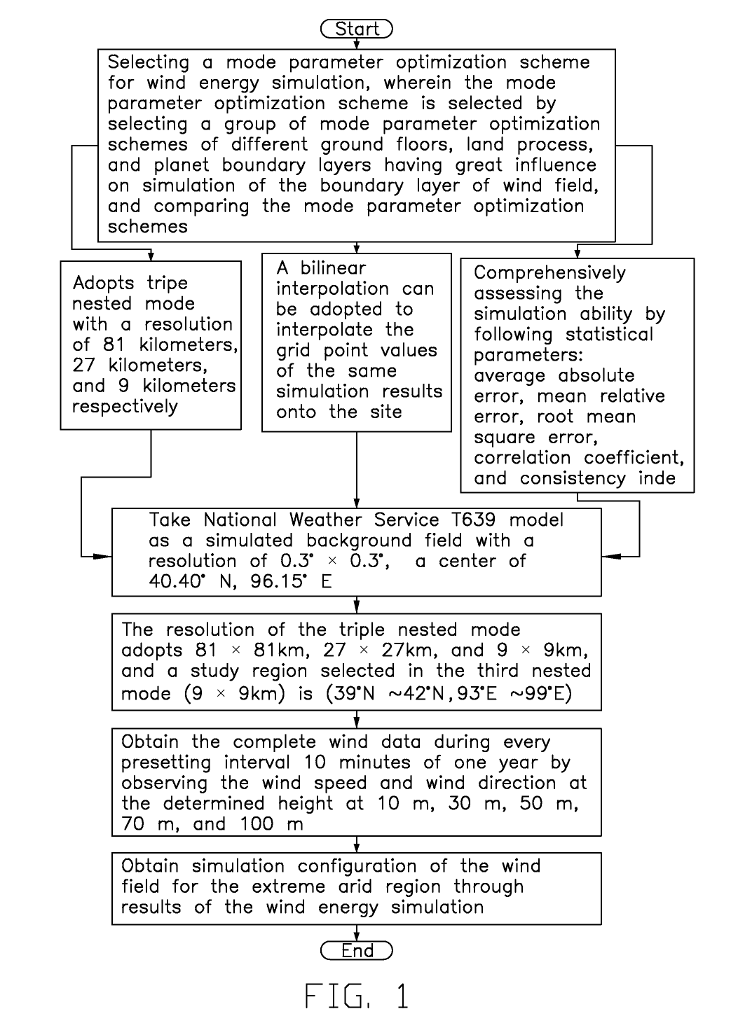

Referring to FIG. 1, a method of simulating wind field of extreme arid region based on WRF comprises:

step (S11), selecting a mode parameter optimization scheme for wind energy simulation, wherein the mode parameter optimization scheme is selected via selecting a mode parameter optimization scheme group of different ground floors, land process, and planet boundary layers having great influence on simulation of the boundary layer of wind field, and comparing the mode parameter optimization schemes;

step (S12), performing a wind energy simulation of the extreme arid region during a preset length of time using the selected mode parameter optimization scheme;

step (S13), obtaining simulation configuration of the wind field for the extreme arid region through result of the wind energy simulation.

In step (S11), the mode parameter optimization scheme can be obtained through tripe nested mode. The resolution can adopt 81 kilometers, 27 kilometers, and 9 kilometers to compare observation point data and experimental simulation results. See the table:

| | ground | | | |
|---|---|---|---|---|
| | floors | land process | planet boundary | |
| | parameters | parameters | layers parameters | |
| | optimization | optimization | optimization | |
| No. | scheme | scheme | scheme | abbreviation |
| 1 | Eta_MO | Noah | MYJ | eta_Noah_MYJ |
| 2 | Eta_MO | RUC | MYJ | eta_RUC_MYJ |
| 3 | MO | Noah | YSU | Mo_Noah_YSU |
| 4 | MO | RUC | YSU | Mo_RUC_YSU |

During comparing observation point data and experimental simulation results, a bilinear interpolation can be adopted to interpolate the grid point values of the same simulation results onto the site. The grid point values can be compared with the site data. The simulation ability of the mode can be comprehensively assessed by following statistical parameters: average absolute error, mean relative error, root mean square error, correlation coefficient, and consistency index.

The root mean square error RMSE is defined as follows:

$$RMSE = {[ \frac{1}{N} {\sum }_{i = 1}^{N} {( {p}_{i} - {o}_{i} )}^{2} ]}^{\frac{1}{2}}$$

wherein pᵢ is the simulation value at the i time; oᵢ is the observation data at the i time; N is the total number of comparative samples.

The smaller the RMSE value, the smaller the error between the simulation value and the observation data is.

The consistency index is defined as:

$$IA = 1 - \frac{{\sum }_{i = 1}^{N} {( {p}_{i} - {o}_{i} )}^{2}}{{\sum }_{i = 1}^{N} {( \vert {p}_{i} - \overline{o} \vert + \vert {o}_{i} - \overline{o} \vert )}^{2}}$$

wherein ō is the average observation data; while IA=1, the simulation value equals to the observation data; while IA=0, the simulation value is independent of observation data; the closer to 1 of the IA, the simulation value is closer to observation data.

Furthermore, roughness length is an important parameter to calculate gas energy exchange. Reijmer et al. study the effect of the roughness length to the climate in Antarctic. The result indicates that, while the roughness length is reduced, the near surface wind speed will be increased, the surface temperature is reduced, the air temperature is increased, and the stability of the atmosphere is improved.

In the WRF model, the roughness length of the bare soil is set to 0.01 meters, which is different from the actual situation. The research analysis of the past 10 years shows that, in extreme arid regions, the magnitude of the roughness length is about 10⁻³ meters. According to the field observation experiment, the roughness length is about 0.0019±0.00071 meters in the extreme arid regions. Thus in the mode parameter optimization scheme, the roughness length can adopt 0.002 meters to replace the original value 0.01 meters.

The soil volumetric heat capacity represents the heat absorbed by the soil while the temperature of the soil rises 1K. The average volumetric heat capacity of the soil between the 2.5 cm and the 7.5 cm in the extreme arid region is about 1.12±0.27×10⁶ J·m⁻³·K⁻¹. Thus the soil volumetric heat capacity in the WRF model is set as 1.12±0.27×10⁶ J·m⁻³·K⁻¹.

Furthermore, the mode parameter optimization scheme can be improved by utilizing the latest achievement of the observation data of the field observation experiment. the improvement steps comprises:

a1, the roughness length of the extreme arid region is set to 0.002 meters in the selected mode parameter optimization scheme;

a2, the soil volumetric heat capacity is set to 1.12×10⁶ J·m⁻³·K⁻¹ in the selected mode parameter optimization scheme;

a3, the surface classification adopts the detailed vegetation classification of NCAR (The National Center for Atmospheric Research).

Furthermore, the improvement steps for the selected mode parameter optimization scheme comprises two sets of control tests and four sets of sensitivity tests:

b1, the two sets of control tests are defined as CTL1 and CTL2, and simulated via original mode (no mode parameter is optimized) and surface classification mode (no mode parameter is optimized);

b2, the four sets of sensitivity tests are defined from STV1˜STV4, in STV1˜STV2, for the two parameters to be optimized, one parameter is optimized and another parameter is retained; in STV4, both two parameters are optimized at the same time.

Furthermore, the step (b1) comprises:

in the control test, the simulation last 8 times, and the integration lasts 72 hours for each time. The simulation results in the former 12 hours are abandoned. The simulation results between the 13-36 hours are selected. Then the simulation results are combined together and last for 8 days. The sample in the simulation is 193 wind speeds.

Furthermore, the step (b2) comprises:

in the sensitivity test, setting the surface roughness length at the sparse vegetation region or bare vegetation region in the extreme arid region to 0.002 meters, and performing the sensitivity test STV1;

setting the soil volumetric heat capacity at the sparse vegetation region or bare vegetation region in the extreme arid region to 1.12×10⁶·m³·K⁻¹, and performing the sensitivity test STV2;

setting the surface roughness length to 0.002 meters and setting the soil volumetric heat capacity to 1.12×10⁶ J·m³·K⁻¹ at the sparse vegetation region or bare vegetation region in the extreme arid region, and performing the sensitivity test STV3;

adopting detailed surface classification, setting the surface roughness length to 0.002 meters and setting the soil volumetric heat capacity to 1.12×10⁶ J·m⁻³·K⁻¹ at the same time at the sparse vegetation region or bare vegetation region in the extreme arid region, and performing the sensitivity test STV4.

In step (S12), the simulated background field is selected from output of the National Weather Service T639 model. The resolution of the data is 0.3°×0.3°. The central of the background field is 40.40° N, 96.15° E. The simulation adopts the triple nested mode, and the resolution can adopt 81×81 km, 27×27 km, and 9×9 km.

The study region selected in the third nested mode (9×9 km) is (39° N˜42° N 93° E˜99° E). The observation data adopts data of anemometer tower.

The simulation results indicates that:

a, the planet boundary layer scheme is more important than the land surface process scheme in the wind field simulation, and the parameterization of the planet boundary layer play a important role in the extreme arid regions.

b, different configurations have different effect to the simulation results. In the 72 hours forecast, the eta_RUC_MYJ scheme and Mo_RUC_YSU are much closer to the observation data of the anemometer tower. After integrating for 10 days, the eta_RUC_MYJ scheme is the best scheme, and the eta_RUC_MYJ is followed.

Furthermore, the step (S12) comprises:

(c1), comparing the observation data and the simulation results via triple nested model during comparing the mode parameter optimization schemes;

(c2), assessing the simulation ability of the mode parameter optimization scheme by interpolating the grid point values of the same simulation results onto the site, and comparing the grid point values with the site data;

(c3), comprehensively assessing the simulation ability by following statistical parameters: average absolute error, mean relative error, root mean square error, correlation coefficient, and consistency index;

(c4), selecting the output of the National Weather Service T639 model as the simulated background field;

(c5), comparing and analyzing the observation data with the anemometer tower data;

(c6), obtaining the complete wind data during a presetting interval of one year by observing the wind speed and wind direction at the determined height.

In step (c1), the resolution adopts 81 km, 27 km, and 9 km respectively in the triple nesting mode.

In step (c4), the simulated background field is selected from output of the National Weather Service T639 model. The resolution of the data is 0.3°×0.3°. The center of the background field is 40.40° N, 96.15° E. The simulation adopts the triple nested mode, and the resolution can adopt 81×81 km, 27×27 km, and 9×9 km. The study region selected in the third nested mode (9×9 km) is (39° N˜42° N, 93° E˜99° E).

In step (c6), the integration time step in the simulation is set to 240 seconds, and the integration is performed for 10 days. The result is output per hour. The results within the former 12 hours are taken as the rotational acceleration time of the mode. The U, V components at height of 10 m, 30 m, 50 m, 70 m, and 100 m within the following 9 and a half days are taken as the simulated results. U, V is horizontal vector of wind speed respectively on different direction, and U and V are perpendicular to each other. The simulated wind speed and observation wind speed are compared and analyzed. The presetting interval can be 10 minutes.

The method of simulating wind field of extreme arid region based on WRF has following advantages. The mode parameter optimization scheme group of different ground floors, land process, and planet boundary layers having great influence on simulation of the boundary layer of wind field are selected, and the mode parameter optimization schemes in the group are compared for the selecting the suitable mode parameter optimization scheme. The wind energy simulation of the extreme arid region is performed during the preset length of time using the selected mode parameter optimization scheme. The simulation configuration of the wind field for the extreme arid region is obtained based on the result of the wind energy simulation. The method utilize the WRF prediction model, and can adopts different configurations for the boundary layer parameterization and land surface parameterization which impact the near-surface wind speed simulation. The method of simulating wind field of extreme arid region based on WRF has high simulation accuracy and can be suitable for large scope.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of simulating wind field of extreme arid region based on WRF, the method comprising:
selecting a mode parameter optimization scheme for wind energy simulation, wherein the mode parameter optimization scheme is selected by selecting a group of mode parameter optimization schemes of different ground floors, land process, and planet boundary layers having great influence on simulation of the boundary layer of wind field, and comparing the mode parameter optimization schemes;
performing a wind energy simulation of the extreme arid region during a preset length of time using the selected mode parameter optimization scheme; and
obtaining simulation configuration of the wind field for the extreme arid region through results of the wind energy simulation.

2. The method of claim 1, wherein the mode parameter optimization scheme is improved by utilizing the latest achievement of the observation data of the field observation experiment.

3. The method of claim 2, wherein the mode parameter optimization scheme is improved by:
a1, a roughness length of the extreme arid region is set to 0.002 meters in the mode parameter optimization scheme;
a2, a soil volumetric heat capacity is set to 1.12×10⁶ J·m³·K⁻¹ in the mode parameter optimization scheme; and
a3, a surface classification adopts the detailed vegetation classification of NCAR in the mode parameter optimization scheme.

4. The method of claim 2, wherein the mode parameter optimization scheme is improved by introducing two sets of control tests and four sets of sensitivity test:
b1, the two sets of control tests are defined as CTL1 and CTL2, and simulated via original mode and surface classification mode; and
b2, the four sets of sensitivity tests are defined from STV1˜STV4, wherein in the STV1˜STV2, one parameter is optimized and another parameter is retained in two parameters to be optimized; in the STV4, both two parameters are optimized at the same time.

5. The method of claim 4, wherein in the control test, the two sets of control tests are simulated for 8 times, and an integration lasts 72 hours for each time to obtain a plurality of simulation results; the simulation results in former 12 hours are abandoned, the simulation results between 13 hours to 36 hours are selected to form 8 days' continuous simulation results with 193 wind speeds as samples.

6. The method of claim 4, wherein the sensitivity test comprises:
setting a surface roughness length at sparse vegetation region or bare vegetation region in the extreme arid region to 0.002 meters, and performing the sensitivity test STV1;
setting a soil volumetric heat capacity at the sparse vegetation region or bare vegetation region in the extreme arid region to 1.12×10⁶ J·m⁻³·K⁻¹, and performing the sensitivity test STV2;
setting a surface roughness length to 0.002 meters and setting the soil volumetric heat capacity to 1.12×10⁶ J·m³·K⁻¹ at the sparse vegetation region or bare vegetation region in the extreme arid region, and performing the sensitivity test STV3; and
adopting detailed surface classification, and setting the surface roughness length to 0.002 meters and setting the soil volumetric heat capacity to 1.12×10⁶ J·m³·K⁻¹ at the same time at the sparse vegetation region or bare vegetation region in the extreme arid region, and performing the sensitivity test STV4.

7. The method of claim 1, wherein the performing a wind energy simulation comprises:
comparing observation data with simulation results via triple nested model during comparing the mode parameter optimization schemes;
assessing a simulation ability of the mode parameter optimization scheme by interpolating grid point values of the same simulation results onto sites, and comparing the grid point values with site data;
comprehensively assessing the simulation ability by following statistical parameters: average absolute error, mean relative error, root mean square error, correlation coefficient, and consistency index;
selecting output of the National Weather Service T639 model as a simulated background field;
comparing and analyzing the observation data with anemometer tower data; and
obtaining a complete wind data during a presetting interval of one year by observing wind speeds and wind directions at the determined height.

8. The method of claim 7, wherein a resolution adopts 81 kilometers, 27 kilometers, and 9 kilometers respectively in the tripe nested mode.

9. The method of claim 7, wherein the simulated background field is selected from output of the National Weather Service T639 model, a resolution of the output is 0.3°×0.3°, a center of the background field is at 40.40° N, 96.15° E, the resolution of the triple nested mode adopts 81×81 km, 27×27 km, and 9×9 km, and a study region selected in the third nested mode (9×9 km) is (39° N˜42° N, 93° E˜99° E).

10. The method of claim 7, wherein an integration time step is set to 240 seconds, the integration is performed for 10 days, results are output per hour, the results within former 12 hours are taken as a rotational acceleration time of the mode; U, V components at height of 10 m, 30 m, 50 m, 70 m, and 100 m within the following 9 and a half days are taken as simulated results, wherein U, V is horizontal vector of wind speed respectively on different direction, and U and V are perpendicular to each other; and the presetting interval is 10 minutes.
